(19) United States
(12) Patent Application Publication
(10) Pub. No.: US 2025/0292261 A1
(43) Pub. Date: Sep. 18, 2025

(54) FUNDING FOR MEMBERSHIP PROGRAMS

(71) Applicant: Tech4X Ventures LLC, San Francisco, CA (US)

(72) Inventor: Ondrej Dusek, San Francisco, CA (US)

(73) Assignee: Tech4X Ventures LLC, San Francisco, CA (US)

(21) Appl. No.: 18/605,485

(22) Filed: Mar. 14, 2024

(51) Int. Cl. G06Q 20/40; G06Q 20/38; G06Q 30/0207

(52) U.S. Cl. CPC G06Q 20/405; G06Q 20/384; G06Q 30/0213

(57) ABSTRACT

A method and system for content creators to interact and collaborate with fans through personal membership licenses. The personal membership licenses are purchased by the fans and provide access to a content creator's membership program. Through the membership programs, content creators and fans can interact and collaborate on projects. The personal membership licenses are transferable.

### CROSS-REFERENCE TO RELATED APPLICATIONS

This application claims the benefit of U.S. Provisional Patent Application Ser. No. 63/490,158 filed Mar. 14, 2023, titled “FUNDING FOR MEMBERSHIP PROGRAMS,” and the subject matter thereof is incorporated herein by reference thereto.

### TECHNICAL FIELD

The present disclosure relates to subscription programs, and more specifically, to subscription programs funded through personal membership licenses.

### BACKGROUND OF THE INVENTION AND PRIOR ART

Traditional “subscription-based” programs use a simple monthly or yearly subscription. While being very simple, these programs have several shortcomings. These shortcomings include, but are not limited to: no “upfront” funding to the creator (who has to invest significant resources to build a membership program, content, etc.), nothing tangible is provided to the fans as part of their membership, and these programs do not build the right mindset for fans as fans do not feel “part of it.”

### SUMMARY OF THE INVENTION

The present disclosure provides a method and system to fund subscription-based membership programs through personal membership licenses (“PMLs”) in a novel way that also provides a different value proposition for fans. The present invention provides a content collaboration application to manage an online community for content creators (“content creators” may also be referred to as “creators” herein) and fans. The content collaboration application comprises rules executable by a rules engine and stored in a database included in a computerized device having a processor and memory and connected to a network.

A content creator creates a membership program that contains their material as desired. Upon opening a membership program, a content creator has the option to issue and sell a certain number of PMLs. PMLs are used as a license for fans (“fans” may also be referred to as “members” herein) to enter and enjoy the benefits of a given content creator's membership program. PMLs are payable upfront, hence providing the content creator with initial funding to further develop and grow the membership program for the fans. As part of the membership program, a content creator can create digital/virtual content creator rooms, also known as “creator spaces.” These content creator rooms can be personalized by the content creator and can be used for specific collaborations with fans, for instance. The content creator rooms can have interactive components such as live comments, polling, voting, suggestions, etc. The content creator rooms also may have modules that are customizable by the content creator, and each module can be specific to a project as specified by the content creator.

The PMLs are “owned” by the fans. The number of available PMLs may be limited as desired by the content creator. PMLs are transferable and resell able, albeit with certain restrictions that are required pursuant to U.S. Securities laws, U.S. Securities and Exchange Commission (SEC) and other regulations. PMLs are designed in such a way so that they do not constitute a security as that term is defined in Section 2(a)(1) of the Securities Act or Section 3(a)(10) of the Securities Exchange Act of 1934.

None of the prior art fully addresses the problems resolved by the present invention. The present invention overcomes these limitations contained in the prior art.

Certain embodiments of the invention have other steps or elements in addition to or in place of those mentioned above. The steps or element will become apparent to those skilled in the art from a reading of the following detailed description when taken with reference to the accompanying figures, if any.

### BRIEF DESCRIPTION OF THE DRAWINGS

FIG. 1 illustrates the steps comprising the method of the content collaboration application.

FIG. 2 illustrates the non-transitory computer-readable medium of the content collaboration application.

FIG. 3 illustrates the computer implemented steps comprising the method of the content collaboration application.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures, if any.

Alternate embodiments have been included throughout, and the order of such are not intended to have any other significance or provide limitations for the present invention.

The words “including”, “comprising”, “incorporating”, “consisting of”, “have”, and “is” are each meant to be non-exclusive, meaning additional items, components or elements may be present. Joinder references such as “connected”, “connecting”, and “coupled” do not limit the position, orientation, or use of systems and/or methods, and do not necessarily infer that two elements are directly connected. All identifying numerical terms are for identification only, and do not refer to the order or preference of any element, embodiment, variation and/or modification. All references to “a” and “an”, as in “a program”, mean “one or more”.

The present invention comprises a method for using a content collaboration application to manage an online community for content creators and fans for a plurality of content creators and a plurality of fans including a first content creator and a first fan, wherein the content collaboration application comprises rules executable by a rules engine and stored in a database included in a computerized device having a processor and memory and connected to a network, the method comprising: creating and storing, using the database, by the content creator a membership program wherein the membership program is associated with specifications for fans to access the membership program as determined by the content creator, whereby the specifications include a monetary amount as determined by the content creator to be paid by the fan to access the membership program, whereby the content creator can include in the specifications a limit on the number of fans that are allowed to access the membership program; storing, using the database, a plurality of profiles for the fans; receiving a request from a fan to access a membership program, wherein the specifications to access the membership program are provided to the fan; providing a personal membership license to the fan upon successful completion of the specifications as provided by the content creator whereby the personal membership license allows access to the membership program, whereby the personal membership license is stored in the database; accessing the membership program by the fan by providing the personal membership license whereby the fan can communicate and collaborate with the content creator and other fans in the membership program; and providing the content creator with the monetary contributions paid by the fans to access the membership program, whereby the contributions are used to support and improve fan experience, maintain and enhance fan benefits, engage with the fans, operate the membership program, and to provide other fan benefits.

The personal membership licenses are transferrable to other fans, and the fans agree to terms and conditions when purchasing a personal membership license. The rules engine executes and processes all rules. The content creators create one or more content creator rooms as part of the membership program, and each content creator room can have interactive components such as live comments, polling, voting, suggestions, etc. A personal membership license may only allow access to one or more of the content creator rooms, as determined by the content creator. The content creator rooms may have modules that are customizable by the content creator. These modules can be specific to a project as specified by the content creator.

The present invention further comprises a non-transitory computer-readable medium having instructions stored thereon, the instructions comprising: receiving a request from a content creator to create a membership program, whereby the membership program is created and designed by the content creator, whereby the content creator provides specifications that must be met in order for a fan to access the membership program, whereby the membership program is stored in a database; receiving from a fan a request to access the membership program, whereby the user is provided the specifications to access the membership program; providing the fan a transferable personal membership license when the specifications have been satisfied, whereby the fan is provided access to the membership program; and storing in the database the personal membership license for each fan.

The present invention further comprises a computer implemented method of a content collaboration application wherein the computer implemented method comprises a content collaboration application which comprises rules executable by a rules engine and stored in a database for execution by one or more processors, the content collaboration application including instructions for, comprising the steps of: creating and storing, using a database and rules executable by a rules engine, a membership program wherein the membership program is created by a content creator and the membership program is associated with specifications for fans to access the membership program as determined by the content creator, whereby the specifications include a monetary amount as determined by the content creator to be paid by the fan to access the membership program, whereby the content creator can include in the specifications a limit on the number of fans that are allowed to access the membership program; storing, using the database, a plurality of profiles for the fans; receiving a request from a fan to access a membership program, wherein the specifications to access the membership program are provided to the fan; providing a personal membership license to the fan upon successful completion of the specifications as provided by the content creator whereby the personal membership license allows access to the membership program, whereby the personal membership license is stored in the database; accessing the membership program by the fan by providing the personal membership license whereby the fan can communicate and collaborate with the content creator and other fans in the membership program; and providing the content creator with the monetary contributions paid by the fan to access the membership program, whereby the contributions are used to support and improve fan experience, maintain and enhance fan benefits, engage with the fans, operate the membership program, and to provide other fan benefits.

The present disclosure provides a system to fund subscription-based membership programs through personal membership licenses (PMLs) in a novel way that also provides a different value proposition for fans (also may be referred to as members throughout). The system of the present invention provides an entire system that comprises the PMLs, the membership programs for the content creators, management and operations of the PMLs and membership programs, purchase of the PMLs, transferring the PMLs, fan access to the PMLs and membership programs, content creator and fan agreements in order to access the PMLs and membership programs, content creator rooms, etc.

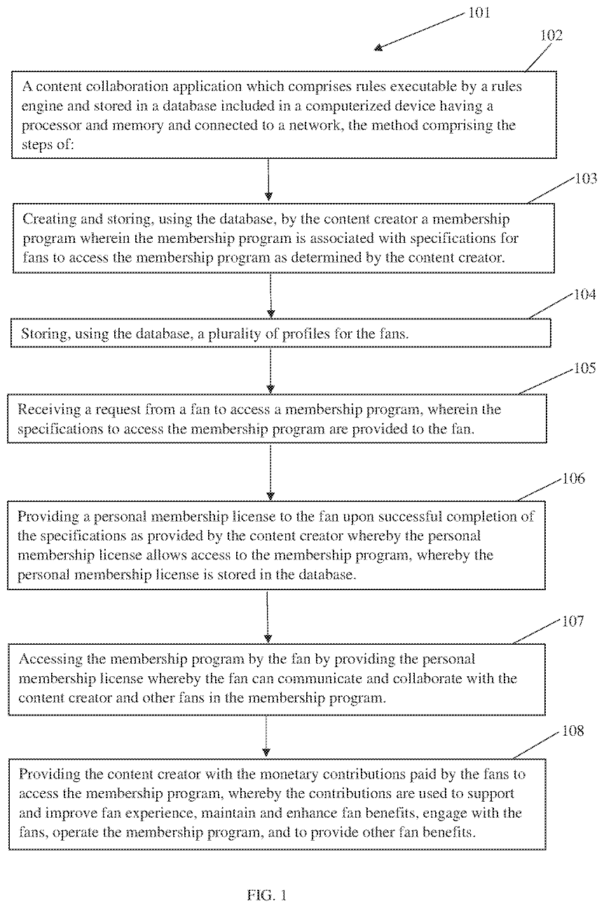

FIG. 1 illustrates the steps comprising method 101 of the content collaboration application of the present invention. Step 102 comprises the content collaboration application to manage an online community for content creators and fans for a plurality of content creators and a plurality of fans including a first content creator and a first fan, wherein the content collaboration application comprises rules executable by a rules engine and stored in a database included in a computerized device having a processor and memory and connected to a network, the method comprising steps 103-108.

Step 103 comprises creating and storing, using the database, by the content creator a membership program wherein the membership program is associated with specifications for fans to access the membership program as determined by the content creator, whereby the specifications include a monetary amount as determined by the content creator to be paid by the fan to access the membership program, whereby the content creator can include in the specifications a limit on the number of fans that are allowed to access the membership program.

Step 104 comprises storing, using the database, a plurality of profiles for the fans.

Step 105 comprises receiving a request from a fan to access a membership program, wherein the specifications to access the membership program are provided to the fan.

Step 106 comprises providing a personal membership license to the fan upon successful completion of the specifications as provided by the content creator whereby the personal membership license allows access to the membership program, whereby the personal membership license is stored in the database.

Step 107 comprises accessing the membership program by the fan by providing the personal membership license whereby the fan can communicate and collaborate with the content creator and other fans in the membership program.

Step 108 comprises providing the content creator with the monetary contributions paid by the fans to access the membership program, whereby the contributions are used to support and improve fan experience, maintain and enhance fan benefits, engage with the fans, operate the membership program, and to provide other fan benefits.

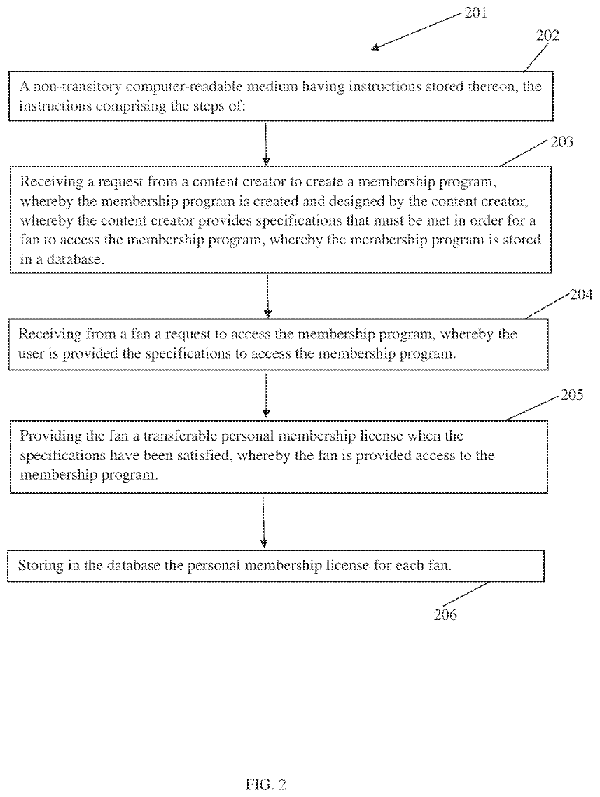

FIG. 2 illustrates the non-transitory computer-readable medium 201 of the content collaboration application of the present invention. Step 201 comprises the non-transitory computer-readable medium having instructions stored thereon, the instructions comprising steps 203-206.

Step 203 comprises receiving a request from a content creator to create a membership program, whereby the membership program is created and designed by the content creator, whereby the content creator provides specifications that must be met in order for a fan to access the membership program, whereby the membership program is stored in a database.

Step 204 comprises receiving from a fan a request to access the membership program, whereby the user is provided the specifications to access the membership program.

Step 205 comprises providing the fan a transferable personal membership license when the specifications have been satisfied, whereby the fan is provided access to the membership program.

Step 206 comprises storing in the database the personal membership license for each fan.

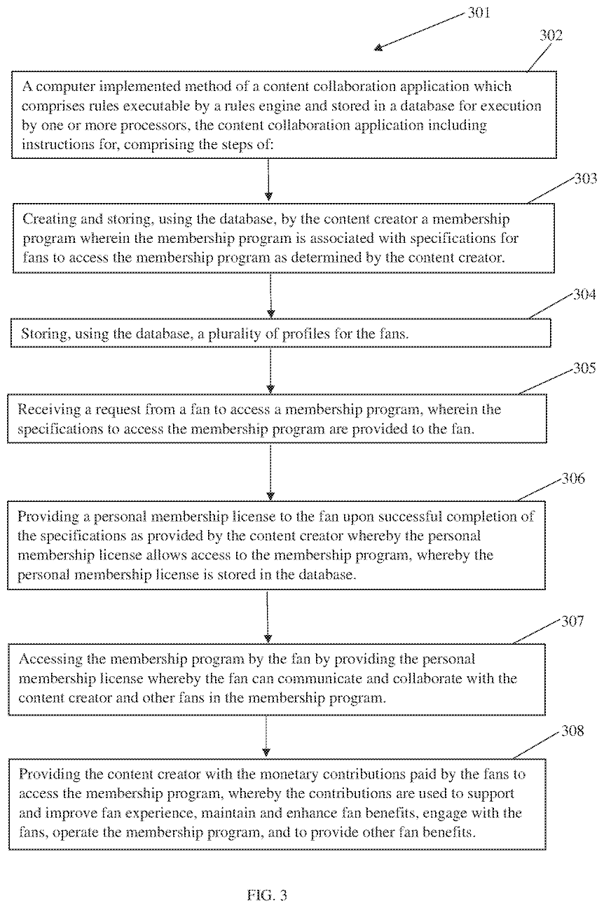

FIG. 3 illustrates the computer implemented steps comprising method 301 of the content collaboration application of the present invention. Step 302 comprises the computer implemented method of a content collaboration application wherein the computer implemented method comprises a content collaboration application which comprises rules executable by a rules engine and stored in a database for execution by one or more processors, the content collaboration application including instructions for, the method comprising steps 303-308.

Step 303 comprises creating and storing, using a database and rules executable by a rules engine, a membership program wherein the membership program is created by a content creator and the membership program is associated with specifications for fans to access the membership program as determined by the content creator, whereby the specifications include a monetary amount as determined by the content creator to be paid by the fan to access the membership program, whereby the content creator can include in the specifications a limit on the number of fans that are allowed to access the membership program.

Step 304 comprises storing, using the database, a plurality of profiles for the fans.

Step 305 comprises receiving a request from a fan to access a membership program, wherein the specifications to access the membership program are provided to the fan.

Step 306 comprises providing a personal membership license to the fan upon successful completion of the specifications as provided by the content creator whereby the personal membership license allows access to the membership program, whereby the personal membership license is stored in the database.

Step 307 comprises accessing the membership program by the fan by providing the personal membership license whereby the fan can communicate and collaborate with the content creator and other fans in the membership program.

Step 308 comprises providing the content creator with the monetary contributions paid by the fan to access the membership program, whereby the contributions are used to support and improve fan experience, maintain and enhance fan benefits, engage with the fans, operate the membership program, and to provide other fan benefits.

To enjoy the benefits of the membership program of the present invention of a given content creator, a fan will complete specifications as provided by the content creator, which may include a member agreement. Once the specifications are successfully completed, the fan may purchase a PML which will grant the fan access to all benefits and perks of the membership program of that content creator. After joining, the fan will pay member dues for the duration of their membership. These dues may be monthly, yearly, or any period as desired by the content creator.

Each content creator has flexibility to set the prices for their PML and dues, depending on the amount of content and benefits provided and type of member group. Multiple levels of membership, or tiers, may be offered by a content creator to a membership program. This could allow greater access to fans who pay a higher price for the PML and/or dues, for example.

The content creator of the present invention may limit or cap the number of PMLs offered to fans, if they choose. Each content creator will decide on the number of PMLs to be issued based on its ability to maintain fan experience and deliver promised fan benefits. A content creator may have any number of PMLs for a given membership program.

The PML is not an investment and does not grant to the fan any ownership or equity share of the content creator's business, any right to own the underlying content or intellectual property, or any right to set policies or make decisions in the membership program. Fans are not entitled to receive any income, dividends, or profits from the to a membership program, nor are they subject to any assessments for additional costs or expenditures incurred by the content creator or the to a membership program. Fans will be advised that the PML is not an investment and that it does not grant the purchaser any of these rights.

The PML and all fan benefits shall be used primarily for personal entertainment, education, and networking purposes by the purchaser of the PML. Everyone who purchases a PML must review and sign an agreement which includes information relating to the ownership of all data, which is part of the specifications as provided herein.

The PML will take the form of an electronic pass owned by each fan. The fan that owns each PML will be recorded on a PML registry (a database). A PML may be used to access a membership program only by an official owner recorded in the PML database. Access to each content creator's membership program will be controlled by using this database to determine if someone attempting to log in to the content creator's membership program is a PML holder appearing on the database with the right to access the content creator's membership program and which also specifies the particular content creator's membership program to which the fan is a member. PMLs will only be issued to one natural person for each membership program offered by a content creator. If a content creator has more than one membership program, a fan may purchase a PML for each membership program offered, but they will not be permitted to purchase more than one PML per membership program. A fan who wishes to purchase a PML as a gift for someone else will be offered the option of purchasing a gift certificate entitling the recipient to obtain a PML, subject to the same terms and conditions (the specifications) as all other fans. In one embodiment of the present invention, different tiers of membership programs are offered, each with different benefits.

The PML and database will enable access to the membership program to be controlled and ensure that no fractionalization of memberships occurs. Each PML is associated with only one fan account and grants access to a membership program for that fan's account. The PML is not divisible technically and practically—each PML is associated with only one fan account and the PML ownership will be tracked on the database.

The holder of a PML is automatically a member of the membership program offered by the content creator that they have chosen. Membership rights to other benefits offered by the content creator, apart from access to the membership program, cannot be separated from the PML and sold, assigned, or transferred to someone else.

The present invention does not allow for issuance of a PML in the form of a Non-Fungible Token (“NFT”) or as a blockchain token. The present invention explicitly prohibits content creators, fans, and third parties from linking or wrapping PMLs to NFTs or blockchain tokens and PMLs will be controlled/monitored through the through internal database. Content creators do not issue the PMLs. They are issued by the rules engine and system of the present invention, at the request of content creators.

In advertising and marketing for the membership programs, content creators can highlight entertainment, education, growing skills, engagement, collaboration, or joint mission and community support, and other benefits of the membership programs. To ensure that content creators do not market PMLs or membership programs as potential investments, the present invention: (a) requires all content creators to properly represent the nature of the PML to any prospective fans/content creators in any marketing communications and to inform prospective fans/content creators that the PML is not an investment and must not be acquired with the expectation of profit and that it is issued for the purpose of providing access to entertainment, education and/or networking; (b) provides template communications and messaging that content creators can utilize that emphasize the entertainment or education benefits of the PMLs for fans; and (c) requires each fan to explicitly agree that they understand the terms of the PML terms and represent that they are buying the PML solely for entertainment or educational use and is not buying the PML as an investment or with any expectations of profit, nor are they buying based on other promises of content creator or other agents, as is provided in the specifications and the content collaboration application.

A PML will not be issued unless written confirmation from a prospective fan is received that they have read, understand, and agree to abide by these terms and conditions and has made these representations. This ensures that the PMLs are not improperly marketed by content creators or by someone else.

In addition, the present invention explicitly warns fans and prospective fans before joining a membership program that participation in the membership program of any content creator must not be viewed as an investment and fans should not expect to derive any profit or capital appreciation from their purchase of the PML or membership in the membership program. Persons purchasing the PML and membership must sign the member agreement and PML agreement agreeing to these terms and conditions, as provided in the specifications and the content collaboration application.

A PML holder is required to pay dues to maintain access to the membership program and their continued right to use the PML. If a fan chooses not to pay their dues or otherwise terminates their membership, the PML will automatically be forfeited and returned to the content creator. A fan may be terminated for violations of any of the agreements and/or policies.

A PML will be transferable only by terms and conditions as part of the specification and the content collaboration application. Except for certain limited transfers as provided in the specifications and/or the content collaboration application, a fan is forbidden from selling, assigning, giving, donating, sublicensing, sharing, hypothecating, pledging, or transferring the PML, and is forbidden from linking the PML to any shared or distributed digital assets such as blockchain tokens or NFTs. Transfers of PMLs are subject to the following restrictions:
(a) Only Permitted Transfers Will Be Allowed: A fan may transfer their PML only with prior written approval of the content collaboration application of the present invention. A PML will not be transferred more than once in a twelve-month period unless the PML transfer is a “Special Event.” A Special Event is defined as (i) the occurrence of a circumstance beyond the control of the fan such as due to his or her death, disability, or loss of employment; or (ii) the transfer of the PML to an immediate family member such as spouse, parent, grandparent, siblings, children or grandchildren, or a related party of a fan living in the same household (such as a domestic partner). It must be verified that a transfer qualifies as a Special Event before the transfer of the PML is permitted.
(b) Use of Designated Third-Party to Arrange Transfers: If it is not a Special Event transfer, a fan can only transfer their PML no more than once in a twelve-month period. The fan must submit their transfer request to an established third-party platform. All transfers on any third-party platforms must comply with all the rules and regulations of the membership programs of the present invention, the specifications, the content collaboration application, and other rules and regulations implemented by the operator of the present invention.
(c) Unpermitted Transfer Attempt of the PML will void the Fan's PML: Any attempt to transfer PML other than as set forth herein is considered an Unpermitted Transfer. This may result in the termination of the PML, the fan's membership, and any rights and benefits associated with it. The content creator will be entitled to keep any funds previously received from the fan who attempted to engage in an Unpermitted Transfer.
(d) Creators and Fans Forbidden from Wrapping PML into NFT or Blockchain token: PMLs will not be issued in the form of a Non-Fungible Token (“NFT”) or as a blockchain token. Instead, an internal database will be used to keep track of all fans and control all transfers of the digital passes it will issue for each PML.

Each fan (whether original PML purchaser or transferee) and each content creator will be required to review and agree to certain specifications, including the member agreement. The member agreement may include, including but not limited to, the following conditions and acknowledgments: the fan is purchasing the PML and acquiring membership in a given content creator's membership program solely for the purpose of gaining access to the membership program and member benefits; fan will pay certain dues as determined by the content creators; the fan is acquiring the PML for entertainment or educational purposes, and not as an investment and should not expect to derive any economic profit or capital appreciation from the purchase of the PM; the fan is not obtaining any ownership or equity share of the content creator's business or income, or intellectual or other property rights to the underlying content, nor the right to set policies or make decisions in the content creator's membership program. Fans will not be entitled to receive any income, dividends, or surpluses from the membership program; the fan is acquiring the PML for their own use and not with the expectation to offer, transfer, duplicate, or resell the PML or engage in any speculative trading activities with the PML; the fan will agree and acknowledge that there is not and will not be any guarantee that a fan will be able to transfer, resell, or return the PML in the future and that any transfer of the PML is subject to restrictions; in case of an attempted transfer of the PML, the fan must not misrepresent the membership program or nature of the PML to potential transferees; and the fan must comply with certain the specifications and all terms and conditions of the content collaboration application.

Content creators are required to use the funds generated through PML sales and regular dues for expenditures consistent with the purpose and objectives of the content creator's membership program and for other designated purposes. Specifically, content creators must use generated funds solely to support and improve fan experience, maintain and enhance fan benefits, engage with the fans, and/or operate the content creator's membership program. All content creators will acknowledge and commit to the use of funds policies in the specifications.

Content creators are prohibited from misrepresenting or describing the PML or a membership program as a potential investment in any of its discussions with or marketing to potential fans. Content creators may be terminated for any violations.

A range of policies, checks, controls, and fraud identification measures are used to prevent fraud or unethical behavior towards fans, content creators, and/or prospective fans. Each content creator's identity and experience will be verified and screened against a set of minimum qualification and trustworthiness criteria prior to launching a membership program. Such criteria will include any of the following, including but not limited to: length of proven content creation experience, size and quality of the content creator's existing content portfolio, size of the content creator's existing audience, the number of the content creator's current followers, the ratings the content creator receives from existing fans/followers, and others criteria. Criteria will be layered and linked to certain limits provided by the content collaboration application of the present invention for the content creator's setting of the PML and the dues as described above.

A content creator is required to have substantial elements of the membership program already in place prior to selling the first PML.

Fans may be granted a trial period for membership to a membership program. If a fan is not satisfied with a membership program, they can request a full refund for the PML and dues paid. New fan payments may be held in an escrow account and will transfer to the content creator only after the successful completion of the trial period.

The content collaboration application of the present invention may utilize automated tools to monitor program health and compliance with implemented policies. The use and attempted transfers of PMLs is monitored.

The content collaboration application of the present invention is responsible for the development and maintenance of the environment, tools, and policies for fans and content creators to enjoy the benefits of individual membership programs. Content creators maintain ownership of all intellectual property rights for content they upload to the membership programs and platform of the present invention.

Among other capabilities, the core responsibilities of the content collaboration application of the present invention may include any of the following, including but not limited to: content creator onboarding, verification, and registration; fan onboarding and registration; tools for content creators to design, build, launch and maintain their membership programs and fan benefits; environment for fan engagement, consumption of fan benefits, collaboration, fan tools, etc.; fraud prevention tools; and payments management and maintaining an escrow account for receipt of funds.

The majority of the costs incurred by running the content collaboration application of the present invention platform will be done through subscription fees paid by participating content creators.

The content collaboration application of the present invention does not intend to charge any fees or commissions on funds generated via the PML sales or from the dues. Hence, the content collaboration application plans to provide all funds generated from the sale of the PMLs and from fan membership dues to the content creators to support their membership programs (except for external costs, such as credit card processing fees). This may change based on business and financial indicators, and other charges may have to be included to content creators, fans, etc.

The content collaboration application of the present invention can be implemented online via the internet, or any other method that allows content creators and fans to access the content collaboration application.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

What is claimed is:

1. A method for using a content collaboration application to manage an online community for content creators and fans for a plurality of content creators and a plurality of fans including a first content creator and a first fan, wherein the content collaboration application comprises rules executable by a rules engine and stored in a database included in a computerized device having a processor and memory and connected to a network, the method comprising:
creating and storing, using the database, by the content creator a membership program wherein the membership program is associated with specifications for fans to access the membership program as determined by the content creator, whereby the specifications include a monetary amount as determined by the content creator to be paid by the fan to access the membership program, whereby the content creator can include in the specifications a limit on the number of fans that are allowed to access the membership program;
storing, using the database, a plurality of profiles for the fans;
receiving a request from a fan to access a membership program, wherein the specifications to access the membership program are provided to the fan;
providing a personal membership license to the fan upon successful completion of the specifications as provided by the content creator whereby the personal membership license allows access to the membership program, whereby the personal membership license is stored in the database;
accessing the membership program by the fan by providing the personal membership license whereby the fan can communicate and collaborate with the content creator and other fans in the membership program; and
providing the content creator with the monetary contributions paid by the fans to access the membership program, whereby the contributions are used to support and improve fan experience, maintain and enhance fan benefits, engage with the fans, operate the membership program, and to provide other fan benefits.

2. The method of claim 1, whereby the personal membership licenses are transferrable to other fans.

3. The method of claim 1, whereby the fans agree to terms and conditions when purchasing a personal membership license.

4. The method of claim 1, whereby the rules engine executes and processes all rules.

5. The method of claim 1, wherein content creators create one or more content creator rooms as part of the membership program.

6. The method of claim 5, whereby the content creator rooms have interactive components such as live comments, polling, voting, suggestions, etc.

7. The method of claim 5, whereby a personal membership license only allows access to one or more of the content creator rooms.

8. The method of claim 5, whereby the content creator rooms have modules that are customizable by the content creator.

9. The method of claim 8, whereby the modules can be specific to a project as specified by the content creator.

10. A non-transitory computer-readable medium having instructions stored thereon, the instructions comprising:
receiving a request from a content creator to create a membership program, whereby the membership program is created and designed by the content creator, whereby the content creator provides specifications that must be met in order for a fan to access the membership program, whereby the membership program is stored in a database;
receiving from a fan a request to access the membership program, whereby the user is provided the specifications to access the membership program;
providing the fan a transferable personal membership license when the specifications have been satisfied, whereby the fan is provided access to the membership program; and
storing in the database the personal membership license for each fan.

11. A computer implemented method of a content collaboration application wherein the computer implemented method comprises a content collaboration application which comprises rules executable by a rules engine and stored in a database for execution by one or more processors, the content collaboration application including instructions for, comprising the steps of:
creating and storing, using a database and rules executable by a rules engine, a membership program wherein the membership program is created by a content creator and the membership program is associated with specifications for fans to access the membership program as determined by the content creator, whereby the specifications include a monetary amount as determined by the content creator to be paid by the fan to access the membership program, whereby the content creator can include in the specifications a limit on the number of fans that are allowed to access the membership program;
storing, using the database, a plurality of profiles for the fans;
receiving a request from a fan to access a membership program, wherein the specifications to access the membership program are provided to the fan;
providing a personal membership license to the fan upon successful completion of the specifications as provided by the content creator whereby the personal membership license allows access to the membership program, whereby the personal membership license is stored in the database;
accessing the membership program by the fan by providing the personal membership license whereby the fan can communicate and collaborate with the content creator and other fans in the membership program; and
providing the content creator with the monetary contributions paid by the fan to access the membership program, whereby the contributions are used to support and improve fan experience, maintain and enhance fan benefits, engage with the fans, operate the membership program, and to provide other fan benefits.

12. The computer implemented method of claim 11, whereby the personal membership licenses are transferrable to other fans.

13. The computer implemented method of claim 11, whereby the fans agree to terms and conditions when purchasing a personal membership license.

14. The method of claim 11, whereby the rules engine executes and processes all rules.

15. The computer implemented method of claim 11, wherein content creators create one or more content creator rooms as part of the membership program.

16. The computer implemented method of claim 15, whereby the content creator rooms have interactive components such as live comments, polling, voting, suggestions, etc.

17. The computer implemented method of claim 15, whereby a personal membership license only allows access to one or more of the content creator rooms.

18. The computer implemented method of claim 15, whereby the content creator rooms have modules that are customizable by the content creator.

19. The computer implemented method of claim 18, whereby the modules can be specific to a project as specified by the content creator.
